(19) United States
(12) Patent Application Publication
(10) Pub. No.: US 2008/0048121 A1
(43) Pub. Date: Feb. 28, 2008

(54) Uncooled Infrared Camera System for Detecting Chemical Leaks and Method for Making the Same

(75) Inventor: Michele Hinnrichs, Solvang, CA (US)

Correspondence Address: QUINN LAW GROUP, PLLC, 39555 ORCHARD HILL PLACE, SUITE # 520, NOVI, MI, 48375, US

(73) Assignee: PACIFIC ADVANCED TECHNOLOGY, Buellton, CA (US)

(21) Appl. No.: 11/844,391

(22) Filed: Aug. 24, 2007

Related U.S. Application Data
(60) Provisional application No. 60/839,894, filed on Aug. 24, 2006.

(51) Int. Cl. G01J 5/10

(52) U.S. Cl. 250/340; 250/352; 250/353

(57) ABSTRACT

An apparatus for detecting incoming radiation, including: a housing for receiving the incoming radiation, a lens attached to the housing to transmit incoming radiation into a radiation shield unit within the housing; a bandpass filter within the radiation shield unit to filter the incoming radiation falling outside a predetermined spectral band; an uncooled infrared detector within the radiation shield unit for detecting infrared radiation; wherein the bandpass filter is located along an optical path between the lens and the infrared detector; and wherein the lens optically focuses the incoming radiation onto the infrared detector. The radiation shield unit, the bandpass filter and the infrared detector are cooled to a temperature slightly less than room temperature, resulting in an improved signal to noise ratio of the image obtained.

### CROSS REFERENCE TO RELATED APPLICATIONS

This application claims the benefit of U.S. Provisional Application No. 60/839,894, filed Aug. 24, 2006, which is hereby incorporated by reference in its entirety.

### TECHNICAL FIELD

The present invention relates generally to infrared cameras. More particularly, the invention relates to an infrared camera system that is cooled to a temperature slightly less than room temperature.

### BACKGROUND OF THE INVENTION

Infrared detectors are used to detect infrared radiation emitted by a target or generally present in the atmosphere. There are two generic types of infrared detectors, those that must be cooled to cryogenic temperatures and those that do not. The ones that operate at near ambient temperatures or are temperature controlled with a thermo-electric cooler are traditionally called uncooled infrared detectors. A significant amount of energy is required to maintain an infrared detector at low cryogenic temperatures.

### SUMMARY OF THE INVENTION

The present invention relates to an infrared camera system using an uncooled infrared detector for detecting infrared radiation, where a radiation shield unit, a bandpass filter and the infrared detector within the infrared camera system are cooled to a temperature slightly less than room temperature. An “uncooled” infrared detector is generally known in the art as a detector that is not cryogenically cooled. The “uncooled” infrared detector has also been referred to in the art as a room-temperature or near-room-temperature detectors. “Room temperature detectors” refer to those detectors kept at above 300 K, while “near-room-temperature detectors” refer to those detectors kept at above 200 K.

An apparatus is provided for detecting incoming radiation, including: a housing for receiving the incoming radiation, a lens attached to the housing to focus and transmit incoming radiation into a radiation shield unit within the housing; a bandpass filter within the radiation shield unit to filter the incoming radiation falling outside a predetermined spectral band; an uncooled infrared detector within the radiation shield unit for detecting infrared radiation; wherein the bandpass filter is located along an optical path between the lens and the infrared detector; and wherein the lens optically focuses the incoming radiation onto the infrared detector.

In one aspect of the invention the radiation shield unit, the bandpass filter and the infrared detector are cooled to a temperature slightly less than room temperature. In another aspect of the invention, the radiation shield unit, the bandpass filter and the infrared detector are cooled to a temperature approximately between 289 K and 308 K. In another aspect of the invention, the radiation shield unit, the bandpass filter and the infrared detector are cooled to a temperature approximately between 289 K and 299 K.

In another aspect of the invention, a thermoelectric cooler is thermally connected to the radiation shield unit is used to cool the radiation shield unit, the bandpass filter and the infrared detector. In another aspect of the invention, a thermoelectric cooler is thermally connected to the radiation shield unit to cool the radiation shield unit, the bandpass filter and the infrared detector, to a temperature of approximately 295 K.

In another aspect of the invention, the cooling by the thermoelectric cooler is configured to improve the signal to noise ratio of an electronic image obtained through electronic processing of the infrared radiation detected by the infrared detector. In another aspect of the invention, a temperature controller is used to adjust the temperature of the thermoelectric cooler.

A method is provided of detecting incoming radiation for an uncooled infrared camera system, the method including: providing a housing for receiving said incoming radiation; attaching a lens to said housing to transmit incoming radiation into a radiation shield unit within said housing; providing a bandpass filter within said radiation shield unit to filter said incoming radiation falling outside a predetermined spectral band; attaching a room-temperature infrared detector to said radiation shield unit for detecting infrared radiation; wherein said bandpass filter is located along an optical path between said lens and said infrared detector; and wherein said lens optically focuses said incoming radiation onto said infrared detector.

The apparatus described above results in an improved signal to noise ratio for the image produced by the uncooled infrared camera system. The traditional method used for uncooled infrared detectors is to heat them above ambient using a thermoelectric cooler. For example and as described below, when a thermoelectric cooler is used to cool the radiation shield unit, the infrared detector and the bandpass filter to below the ambient temperature, at about 289 K, the signal to noise improvement of the camera is such that a gas leak signal that is obtained is about 3 orders of magnitude smaller compared to the gas leak signal obtained using an uncooled infrared camera system operated in the normal mode of operation. The normal mode of operation for an uncooled infrared camera system is to keep it at an elevated temperature above ambient temperature. The improvement in the signal to noise ratio allows narrow band infrared imaging of chemical gases that have absorption bands matching the bandpass filter.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of an infrared camera system where the radiation shield unit, bandpass filter and infrared detector are cooled to a temperature below ambient temperature as described below, according to a preferred embodiment of the invention;

FIG. 2 is a schematic diagram illustrating the mode of operation of the uncooled infrared camera system;

FIG. 3 is a flow chart showing the mode of operation of the uncooled infrared camera system;

FIG. 4 shows an electronic infrared image produced by an uncooled infrared camera system utilizing an uncooled infrared detector at an elevated temperature above ambient temperature, which is the normal mode of operation for uncooled detectors; and

FIG. 5 shows an improved electronic infrared image produced by the uncooled infrared camera system cooled to a temperature below ambient temperature, according to a preferred embodiment of the invention.

### DESCRIPTION OF THE PREFERRED EMBODIMENTS

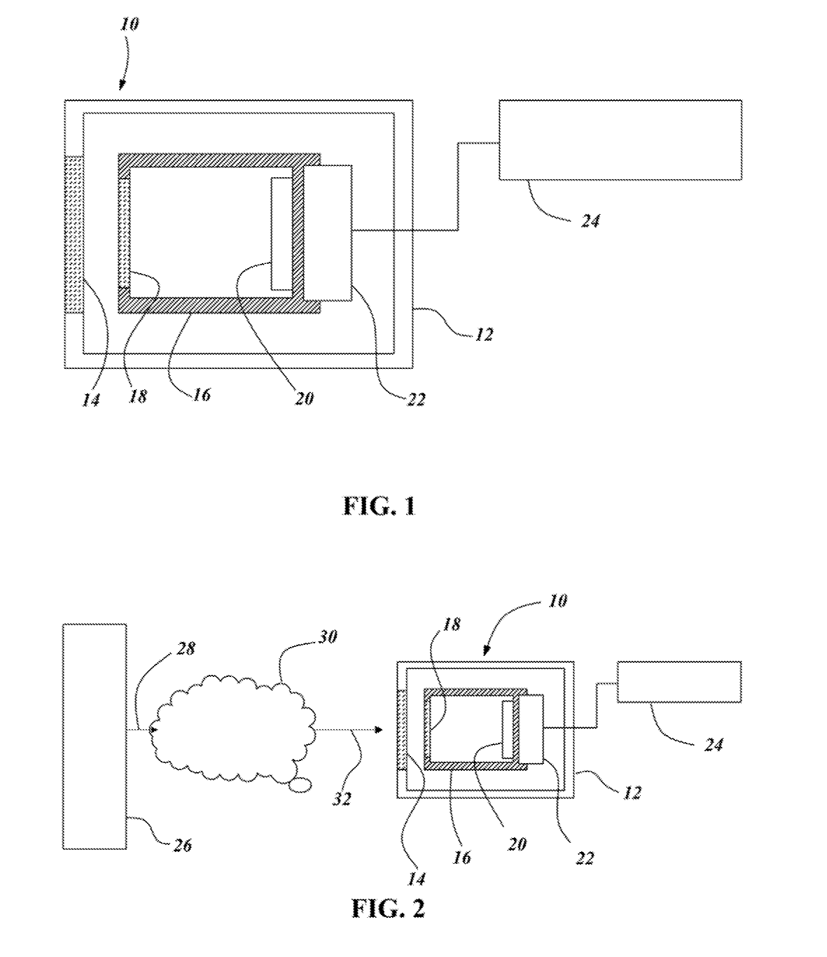

FIG. 1 is a schematic diagram of an uncooled infrared camera system 10, according to a preferred embodiment of the invention. The uncooled infrared camera system 10 is adapted to provide visible imaging of chemical fluids including gases and liquids. The chemical fluid may be a vapor or aerosol suspended in air, or a liquid on a surface. This allows the uncooled infrared camera system 10 to detect chemicals leaked or spilled in the environment.

The uncooled infrared camera system 10 includes a mechanical housing 12, at least one window or lens 14, a radiation shield unit 16, a bandpass filter 18 and an uncooled infrared detector 20, a thermoelectric cooler 22 and a temperature controller 24. The mechanical housing 12 provides structural rigidity to the uncooled infrared camera system 10 and protects the radiation shield unit 16, the band-pass filter 18, the uncooled infrared detector 20 and the thermoelectric cooler 22. The housing 12 further maintains a controlled environment for the uncooled infrared detector 20 and bandpass filter 18. The housing 12 includes at least one window or lens 14 for radiation transmission, and optically focusing an image on the uncooled infrared detector 20.

The radiation shield unit 16 is adapted to reduce the amount of stray light or infrared radiation from reaching the solid state imaging array (not shown) in the uncooled infrared detector 20. The radiation shield unit 16 may be made of metal or any other suitable material. The infrared radiation travels into the radiation shield unit 16 via the bandpass filter 18.

The bandpass filter 18 is located along an optical path between the window or lens 14 and the uncooled infrared detector 20. Spectral band pass filters 18 are traditionally made on substrates such as germanium or silicon for the infrared spectral region or glass for the visible spectral region, they are coated with thin films that pass radiation within a spectral region of interest. The spectral band of interest may cover the absorption spectral region of a specific chemical gas. In one embodiment, different bandpass filters 18 may be used for different chemicals. For example, from about 3.2 to about 3.6 micron, the bandpass filter 18 may be used to detect hydrocarbon gases, about 10.5 to about 10.7 micron bandpass filter 18 may be used to detect sulfurhexafluoride, and about 4.2 to about 4.5 micron bandpass filter 18 may be used to detect carbon dioxide.

The uncooled infrared detector 20 receives infrared radiation entering the radiation shield unit 16. As noted above, an uncooled infrared detector 20 is known in the art as a detector that is not cryogenically cooled to 77 K or below. The uncooled infrared detector 20 has also been referred to in the art as room-temperature and/or near-room-temperature sensor. “Room temperature detectors” refer to those detectors kept at above 300 K, while “near-room-temperature detectors” refer to those detectors kept above 200 K. The uncooled infrared detector 20 may utilize microbolometer, ferroelectric, and pyroelectric technologies. The uncooled infrared detector 20 may also use HgCdTc detector materials that are temperature stabilized with the thermoelectric cooler 22.

In the preferred embodiment of the invention, the uncooled infrared detector 20, the bandpass filter 18 and the radiation shield unit 16 are cooled using a thermoelectric cooler 22 thermally connected or attached to the radiation shield unit 16. Any other method of cooling may be used. In the preferred embodiment, a Peltea Cooler is used to stabilize the temperature to the desired range, preferably ranging from about 289 K to about 308 K. A temperature controller 24 may be used to adjust the temperature of the thermoelectric cooler 22.

Unlike cryogenically cooled infrared camera systems, the uncooled infrared camera system 10 may require only slight cooling from ambient temperature. Since more energy is required to maintain an infrared detector at low cryogenic temperatures of about 77 K, the present invention improves the energy consumption of infrared camera systems by requiring slight cooling.

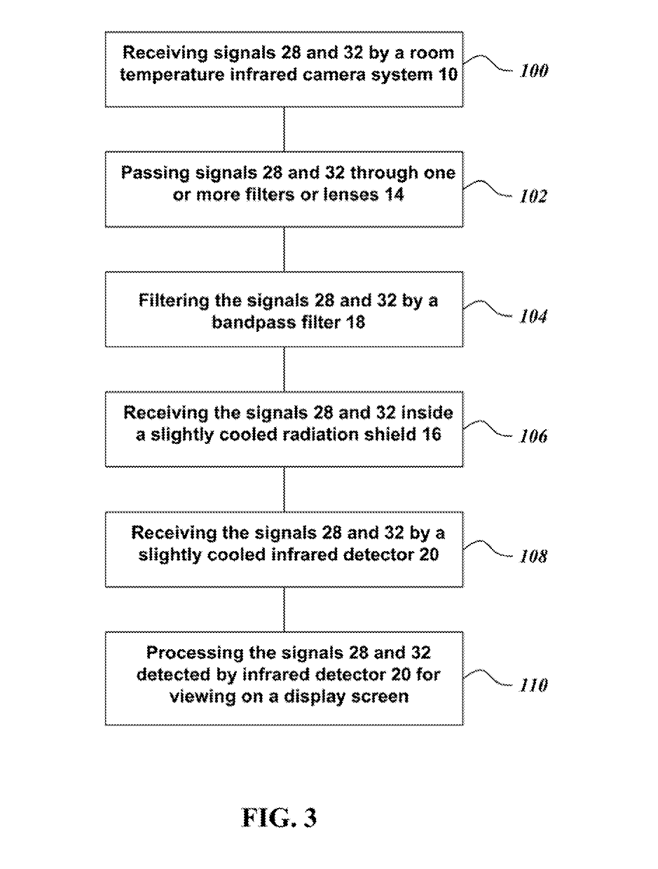

FIGS. 2 and 3 illustrate the method for detecting a chemical fluid, such as a chemical gas cloud, using the uncooled infrared camera system 10, according to a preferred embodiment of the invention. FIG. 2 is a schematic diagram illustrating the mode of operation of the uncooled infrared camera system 10, wherein like reference numbers refer to like items. FIG. 3 is a flow chart showing the mode of operation of the uncooled infrared camera system 10, wherein like reference numbers refer to like items. Infrared radiation, represented by background infrared signals 28, may be emitted at relatively constant low levels from background sources 26 such as building materials, earth soil or rock, or simply from the atmosphere. Referring to FIG. 2, the background infrared signals 28 may be attenuated or absorbed by a gas cloud 30. The attenuated signals 32, along with background infrared signals 28 unobstructed by the gas cloud 30 (collectively “signals 28 and 32”), are received by the uncooled infrared camera system 10 as described above, shown in FIG. 2 and at block 100 in FIG. 3. The signals 28 and 32 pass through one or more windows or lenses 14, shown at block 102. The signals 28 and 32 are then filtered by the bandpass filter 18, shown at block 104. The signals 28 and 32 enter a slightly cooled radiation shield unit 16, shown at block 106. The signals 28 and 32 are received by a slightly cooled infrared detector 20, shown at block 108, and are electronically processed for viewing on a display screen, shown at block 110 in FIG. 3.

### Improvement in Signal to Noise Ratio

The infrared images received by the uncooled infrared detector 20 may be electronically processed and viewed on a display screen (not shown) that is electrically connected to the uncooled infrared detector 20. Using the thermoelectric cooler 22 as described above for slight cooling of the uncooled infrared detector 20, the bandpass filter 18 and the radiation shield unit 16 (shown in FIGS. 1-2), to a temperature slightly below room temperature results in a significant improvement in the signal to noise ratio of the image obtained.

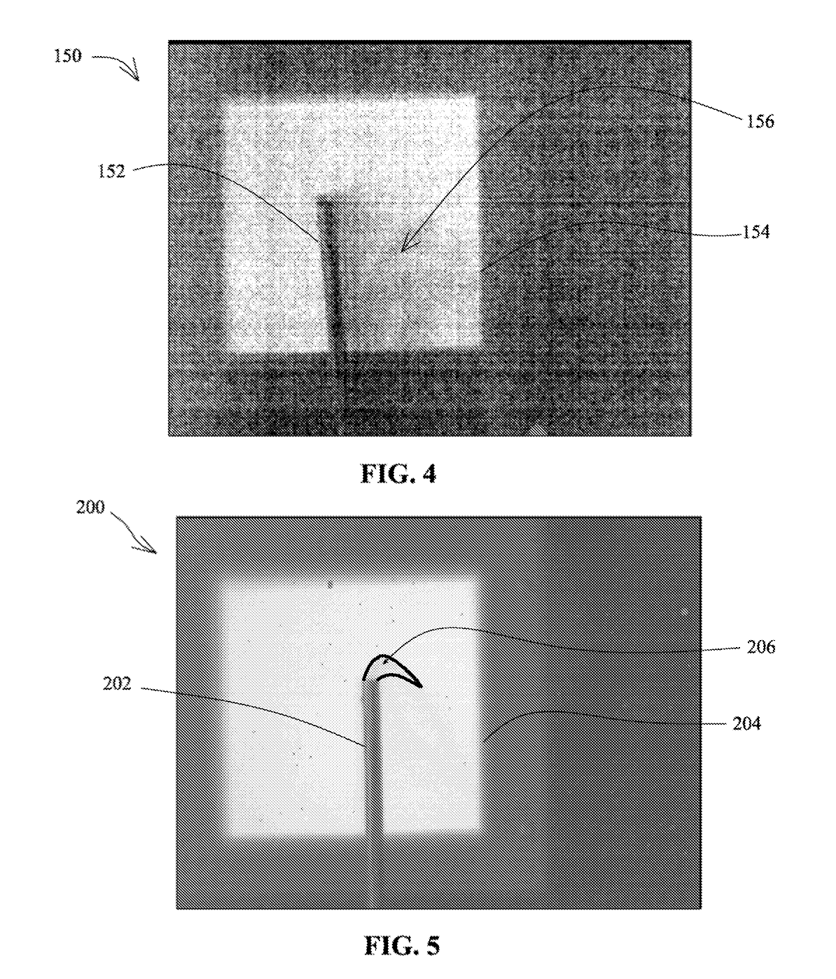

FIG. 4 shows an image 150 obtained with an uncooled infrared camera system that stabilizes the temperature of an uncooled infrared detector at an elevated temperature above ambient temperature, as is the normal mode of operation for uncooled infrared detectors. FIG. 5 shows an improved image 200 using a thermoelectric cooler 22 to cool the infrared detector 20, the bandpass filter 18, and the radiation shield unit 16 (shown in FIGS. 1-2), to a temperature below ambient temperature, at approximately 289 K (or 16 Celsius).

FIG. 4 shows a narrow band infrared spectral image 152 of a gas with an absorption band matching the bandpass filter used. A narrow band optical band pass filter that covered the spectral region from 10.55 to 10.65 microns was used to obtain the images for FIGS. 4-5. FIG. 5 shows an improved spectral image 202 of the gas with an absorption band matching the bandpass filter used. In FIGS. 4 and 5, the gas was flown through an aluminum tube (seen in the shape of the spectral images 152, 202) which was placed in front of a blackbody (shown at 154 in FIG. 4 and 204 in FIG. 5), a plate painted with flat black giving an emissivity close to 1 and temperature controlled with thermal resistive heating elements on the back. The infrared image is a gray scale image where white is hotter and black is cooler. The blackbody 154, 204 appears white in the images 150, 200, in FIGS. 4 and 5, respectively, since it is the hottest object in the scene.

The improved spectral image 202 of FIG. 5 has a leak signal 206 (outlined) that is about 3 orders of magnitude smaller than the leak signal 156 of the spectral image 152 shown in FIG. 4. The improvement in the signal to noise ratio in the improved spectral image 202 of FIG. 5 is apparent as is the sensitivity of the detector array (not shown) to the narrow band spectral image of the gas. The improvement in the signal to noise ratio allows narrow band infrared imaging of chemical gases that have absorption bands matching the particular bandpass filter used.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

While the best modes for carrying out the invention have been described in detail, those familiar with the art to which this invention relates will recognize various alternative designs and embodiments for practicing the invention within the scope of the appended claims. For example, a person skilled in the art would appreciate that any temperature between ambient temperature and extreme cryogenic temperature of 77 K may be used to achieve the object of the invention without departing from its scope and spirit.

1. Apparatus for detecting incoming radiation, comprising:
a housing for receiving said incoming radiation;
a lens attached to said housing to transmit incoming radiation into a radiation shield unit within said housing;
a bandpass filter within said radiation shield unit to filter said incoming radiation falling outside a predetermined spectral band;
an uncooled infrared detector within said radiation shield unit for detecting infrared radiation;
wherein said bandpass filter is located along an optical path between said lens and said infrared detector; and
wherein said lens optically focuses said incoming radiation onto said infrared detector.

2. The apparatus of claim 1, wherein said radiation shield unit, said bandpass filter and said infrared detector are cooled to a temperature slightly less than room temperature.

3. The apparatus of claim 1, wherein said radiation shield unit, said bandpass filter and said infrared detector are cooled to a temperature approximately between 289 K and 308 K.

4. The apparatus of claim 1, wherein said radiation shield unit, said bandpass filter and said infrared detector are cooled to a temperature approximately between 289 K and 299 K.

5. The apparatus of claim 1, wherein a thermoelectric cooler thermally connected to said radiation shield unit is used to cool said radiation shield unit, said bandpass filter and said infrared detector.

6. The apparatus of claim 1, further comprising a thermoelectric cooler thermally connected to said radiation shield unit to cool said radiation shield unit, said bandpass filter and said infrared detector, to a temperature of approximately 295 K.

7. The apparatus of claim 5, wherein said radiation shield unit is composed of metal.

8. The apparatus of claim 7, further comprising a temperature controller to adjust the temperature of said thermoelectric cooler.

9. The apparatus of claim 8, wherein said cooling by said thermoelectric cooler is configured to improve the signal to noise ratio of an electronic image obtained through electronic processing of said infrared radiation detected by said infrared detector.

10. An uncooled infrared camera system for imaging chemicals, comprising:
a housing for receiving said incoming radiation,
a lens attached to said housing to transmit incoming radiation into a radiation shield unit within said housing;
a bandpass filter within said radiation shield unit to filter said incoming radiation falling outside a predetermined spectral band;
an uncooled infrared detector within said radiation shield unit for detecting infrared radiation;
a thermoelectric cooler thermally connected to said radiation shield unit to cool said radiation shield unit, said bandpass filter and said infrared detector, to a temperature approximately between 289 K and 299 K;
wherein said bandpass filter is located along an optical path between said lens and said infrared detector; and
wherein said lens optically focuses said incoming radiation onto said infrared detector.

11. The camera system of claim 10, wherein said radiation shield unit is composed of metal.

12. The camera system of claim 11, further comprising a temperature controller to adjust the temperature of said thermoelectric cooler.

13. A method of detecting incoming radiation for an uncooled infrared camera system, the method comprising:
receiving said incoming radiation into a housing in a manner such that the incoming radiation passes through a lens into a radiation shield unit within said housing;
filtering said incoming radiation which falls outside a predetermined spectral band with a bandpass filter attached to said radiation shield unit;
detecting infrared radiation in said incoming radiation with a room-temperature infrared detector attached to said radiation shield unit;
wherein said bandpass filter is located along an optical path between said lens and said infrared detector; and
wherein said lens optically focuses said incoming radiation onto said infrared detector.

14. The method of claim 13, further comprising cooling said radiation shield unit, said bandpass filter and said infrared detector to a temperature slightly less than room temperature.

15. The method of claim 13, further comprising cooling said radiation shield unit, said bandpass filter and said infrared detector to a temperature approximately between 289 K and 308 K.

16. The method of claim 13, further comprising cooling said radiation shield unit, said bandpass filter and said infrared detector to a temperature approximately between 289 K and 299 K.

17. The method of claim 13, further comprising cooling said radiation shield unit, said bandpass filter and said infrared detector to a temperature of approximately 295 K, through a thermoelectric cooler thermally connected to said radiation shield unit.

18. The method of claim 14, wherein a thermoelectric cooler thermally connected to said radiation shield unit is used to cool said radiation shield unit, said bandpass filter and said infrared detector.
